(19) United States
(12) Patent Application Publication
(10) Pub. No.: US 2003/0171986 A1
(43) Pub. Date: Sep. 11, 2003

(54) Linked promotional bingo game

(76) Inventors: Yuri Itkis, Las Vegas, NV (US); Boris Itkis, Las Vegas, NV (US)

Correspondence Address: QUIRK & TRATOS, 3773 HOWARD HUGHES PARKWAY, SUITE 500 NORTH, LAS VEGAS, NV, 89109, US

(21) Appl. No.: 10/093,023

(22) Filed: Mar. 5, 2002

(51) Int. Cl. G06F 17/60

(52) U.S. Cl. 705/14; 463/25

(57) ABSTRACT

A bingo pack printed by a printer responsive to a computer consisting of a plurality of bingo pages imprinted with at least one bingo card and a reference corresponding to a bingo game, including but not limited to, a game name, a game number and/or a bingo pattern. A bingo pack is dispensed to a player from a self-service computer-controlled printing kiosk. The kiosk displays a menu of available bingo packs on a touchscreen display and accepts currency, credit cards and refund vouchers. Bingo packs dispensed from the kiosk may be printed on paper of various colors, indicating a prize level. Each bingo page comprising a printed bingo pack may be imprinted with a pack identification number, date, bingo hall name, advertisement, coupon, sweepstakes identification, player's name and/or player identification number. In addition to paper bingo cards, kiosks may transmit electronic bingo cards to electronic bingo player units.

### BACKGROUND OF THE INVENTION

Free bingo games are offered on many Internet sites, such as bingo.com, zanybingo.com and freeonlinebingo.com. The sites offering free bingo derive revenue by placing advertisements or commercials shown on the screens of Internet terminals. A portion of the advertising revenues may be offered to Internet bingo players as prizes. Typically, such prizes are of nominal value, and often, the very same inexpensive consumer products being advertised are offered as prizes. Nevertheless, being free, such bingo games are attractive for bingo aficionados. However, Internet bingo games have a limited audience, are not conducive to social interaction between players and require a dedicated Internet terminal for each player. Free small-prized bingo games are also offered by some casinos to attract bingo players. Since bingo players are commonly avid slot players, casinos offering free bingo games benefit as the bingo players remain to play slot machines once a free bingo session is concluded.

On the other hand, large sweepstake-style prizes, often times in the millions of dollars, are offered by fast food and supermarket chains. A patron of a commercial establishment participating in such a sweepstakes promotion typically receives a free sweepstakes entry every time he or she visits an establishment as disclosed, for example, in U.S. Pat. No. 4,982,346 to Girouard et al., and U.S. Pat. No. 4,669,730 to Small. The conventional sweepstakes are similar to instant lottery tickets and pull-tabs, except they are free. The sweepstakes format is designed to encourage frequent, but typically brief, visits by patrons to establishments participating in the sweepstakes promotion. Being directed to a quick-service environment, sweepstakes promotions are not readily applicable to prolonged-service oriented commercial establishments, such as bars, pubs, restaurants and clubs. It is worth noting also that conventional sweepstakes tickets are insufficiently secure. Yet, in view of the current trend of declining overall attendance, bars, pubs and clubs are in dire need of attracting patrons with promotions, and not less importantly, to retain visitors for longer periods of time. In today's environment, the conventional “happy hour” is no longer an effective promotional too. Since the appeal of a promotional sweepstakes game is proportional to the value of the offered prize(s), it is highly desirable to offer large promotional prizes to patrons of bars, pubs and clubs. However, a single bar is typically not in a financial position to afford a large promotional prize. A common technique of offering large bingo prizes is linking a plurality of bingo halls in a common bingo game having a progressive jackpot prize. For example, the MegaBingo game is conducted simultaneously on a number of Indian Reservations. However at least two serious problems prevent direct application of linked bingo games to bars, clubs and similar commercial establishments, namely a questionable legality and a high cost of conducting such games.

First, in a majority of jurisdictions, bars and similar establishments are legally precluded from selling bingo cards to patrons and, quite likely, are not allowed to conduct even a free bingo game. A technique of circumventing some legal restrictions is offering players a keno-style machine that in reality is nothing but a video terminal controlled by a file server that executes a legally permissible pull-tab game as disclosed in U.S. Pat. No. 6,138,361 to Cummings et al., and U.S. Pat. No. 5,324,035 to Morris et al. However, the technique is not directly applicable to a bar environment for a number of reasons. First, it would be extremely unlikely for a government to legalize devices looking in appearance like slot machines for use in bars. Second, such video terminals are prohibitively expensive for the bar industry. Third, a game of keno requires a player input for selection of specific keno numbers, and therefore, even if players were to use conventional keno cards instead of operating video keno terminals, a relatively complicated terminal capable of scanning players' keno cards is still required. Moreover, the game of keno disclosed in Cummings and Morris is vastly different from a live bingo game in many aspects. For example, keno terminals display keno game outcomes virtually instantaneously. In comparison, a bingo game is typically a slow and deliberate game ideally suited for the purpose of prolonging patrons' attendance at commercial establishments.

Even assuming bars and similar establishments were able to legally offer bingo games for a fee, the linked bingo games are typically more expensive for players than non-linked bingo games. Therefore, conventional linked bingo games are not cost effective when utilized as a promotional tool by bars and similar establishments. Moreover, the accepted format of linked bingo games requires the maximum concentration of players manually daubing bingo cards, whereas bars strive to provide a relaxed environment for their patrons and can ill-afford to distract their patrons from the customary bar activities. Although an alternative to manually daubing bingo cards is offered by electronic bingo player units playing bingo cards automatically, such as disclosed in U.S. Pat. Nos. 4,455,025 and 4,624,462 both to Itkis, the electronic bingo player units are generally too expensive to offer free of charge to bar patrons.

A perennial problem with any type of promotional activity is funding such an activity from available sources. In this regard, a free live promotional bingo game of bingo presents a special challenge of attracting bingo players who are accustomed to large prizes. Heretofore, the challenge was left unanswered.

### SUMMARY OF THE INVENTION

It is a primary objective of the present invention to provide commercial establishments, such as bars, pubs and clubs with an effective promotional tool capable of attracting patrons while extending patrons' visits.

It is an additional objective of the present invention to attract patrons by offering them free promotional games with large prizes.

A further objective of the present invention is to provide such games in a legally permissible manner.

A further objective of the present invention is to offer such games in a prolonged format encouraging patrons to extend their visits to such establishments.

Yet another objective of the present invention to provide funding for such free promotional games from commercial sources.

These and other objectives will become more apparent from the following drawings and the detailed description of the preferred embodiment.

The above objectives of the present invention are achieved by conducting linked large-prized bingo games simultaneously throughout a large number of bars and similar establishments at no cost to patrons of the establishments and in compliance with free sweepstakes laws and regulations. Moreover, funding the linked bingo games from at least one of the following sources: (a) charging each participating commercial establishment a relatively small participation fee for each free game card issued by the establishment to its patrons; (b) displaying commercials to game participants and charging advertisers fees for the privilege to display their commercials; and (c) maintaining databases of patrons participating in free games and selling targeted mailing lists that utilize the data accumulated in the databases.

Specifically, the invention attempts to create an appearance of a live linked bingo game being conducted simultaneously in a number of participating commercial establishments. In each of the participating establishments, a self-service vending kiosk prints and issues free game tickets imprinted with bingo cards to patrons who swipe their player-tracking cards through the kiosk's magnetic card reader in order to obtain a free game ticket. Preferably, only one free game ticket is issued per patron per game. The vending kiosk also displays simulated called bingo balls and the winning bingo card on its screen. However, the winning bingo card is not truly a bingo card having bingo numbers matching called bingo numbers for a bingo pattern being played. On the contrary, it is rather called bingo numbers that are artificially generated to match a specific bingo card imprinted on a specific free sweepstakes ticket that is randomly selected, by a remotely located central file server, from amongst all free game tickets distributed to patrons of the establishments before the simulated bingo game even begins. Admittedly, such a simulated bingo game may be called a “fake” or a “fixed game”, yet the players do not pay anything to participate in the simulated game, may not even know that the game is only a simulation and if the game is presented in an entertaining fashion, players may enjoy the game nonetheless. It should be understood that each participating establishment may be legally required to post a disclosure of the true nature of the game.

### BRIEF DESCRIPTION OF THE DRAWINGS

FIG. 1 illustrates a block diagram and related flow charts depicting operation of a gaming network linking together a plurality of bars conducting a free linked bingo game;

FIG. 2 illustrates a free sweepstakes ticket including a bingo card;

FIG. 3 illustrates a magnetic-stripe player card;

FIG. 4 illustrates an image displayed on a screen of a ticket dispensing kiosks; and

FIG. 5 illustrates a flowchart depicting a procedure precluding appearance of more than one winner in a simulated bingo game;

### PREFERRED EMBODIMENT

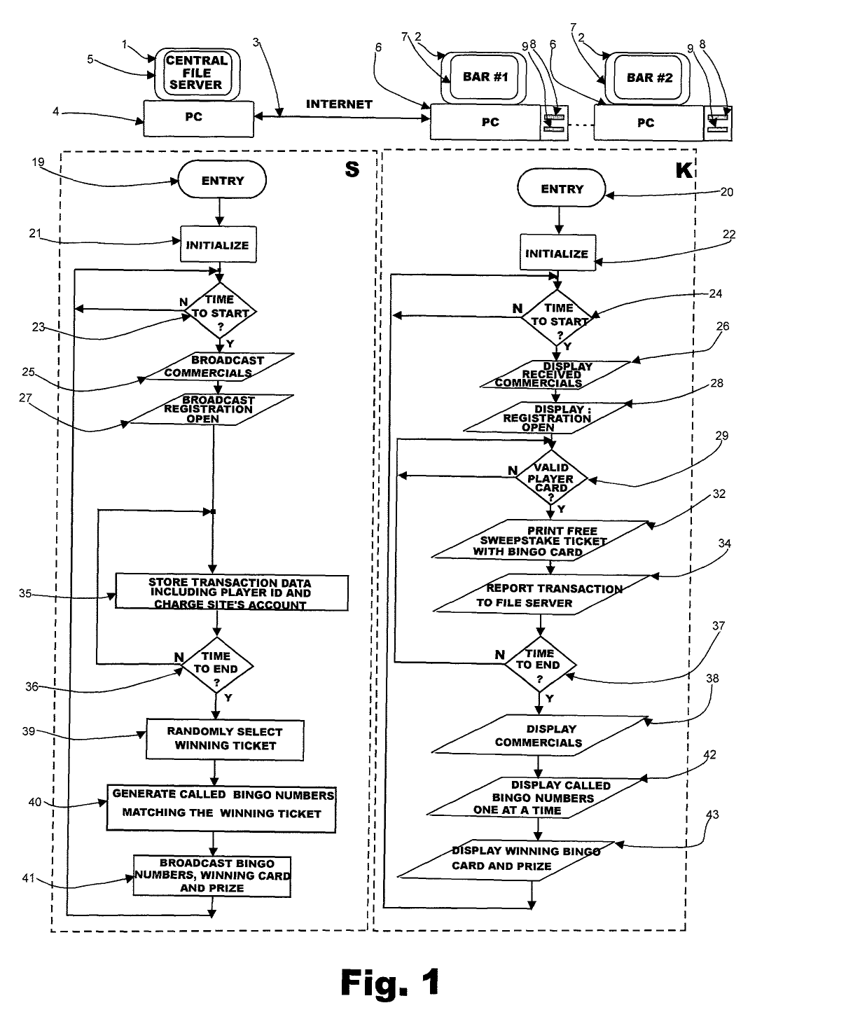

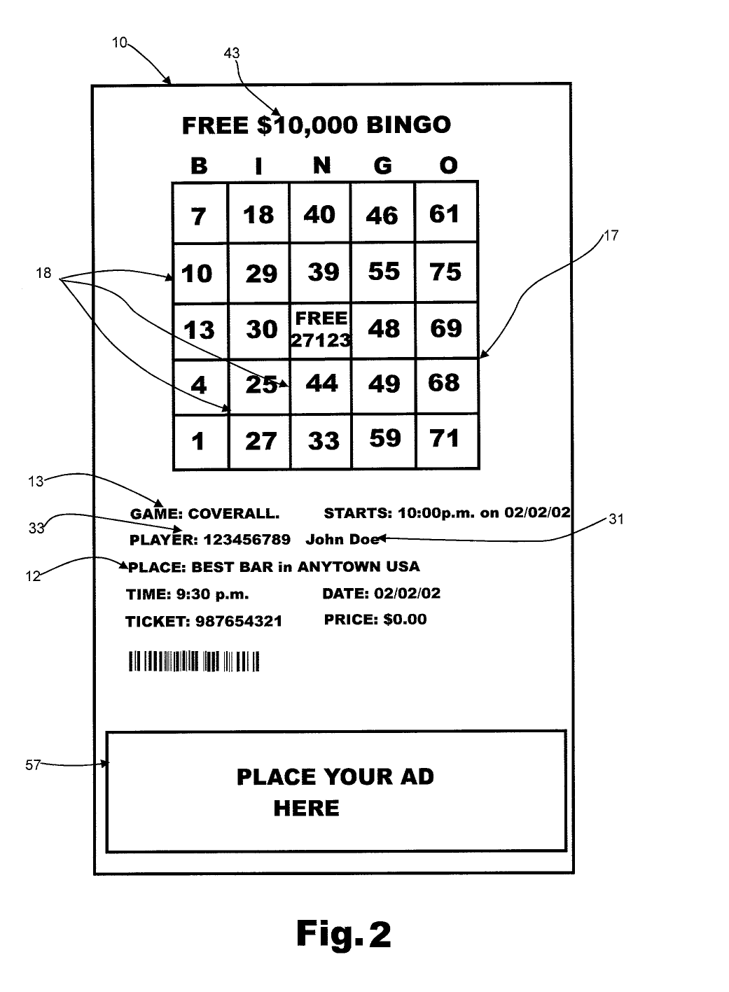

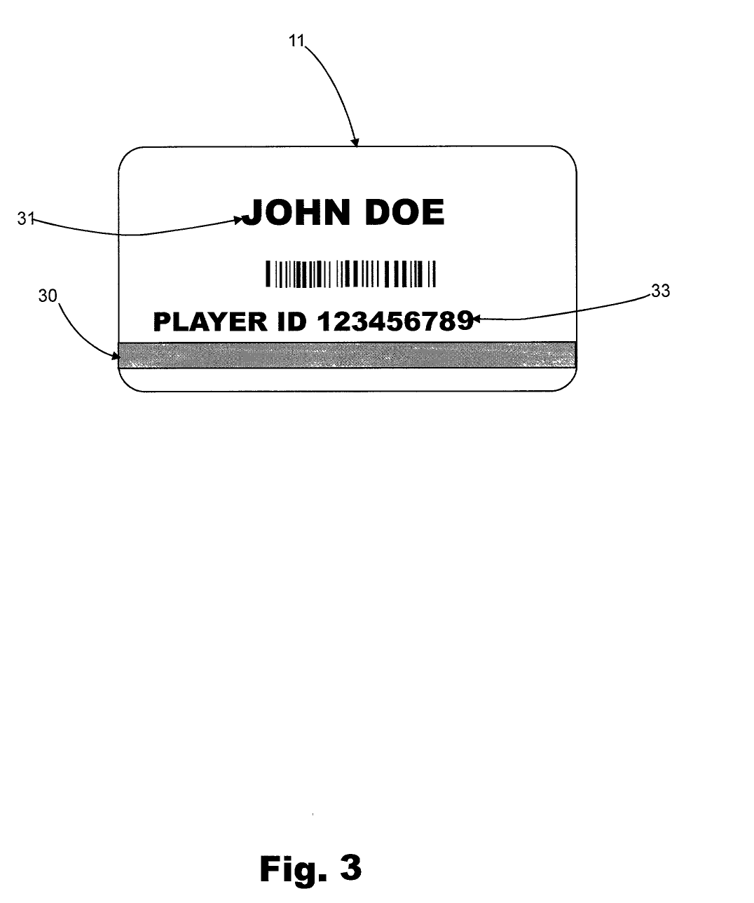

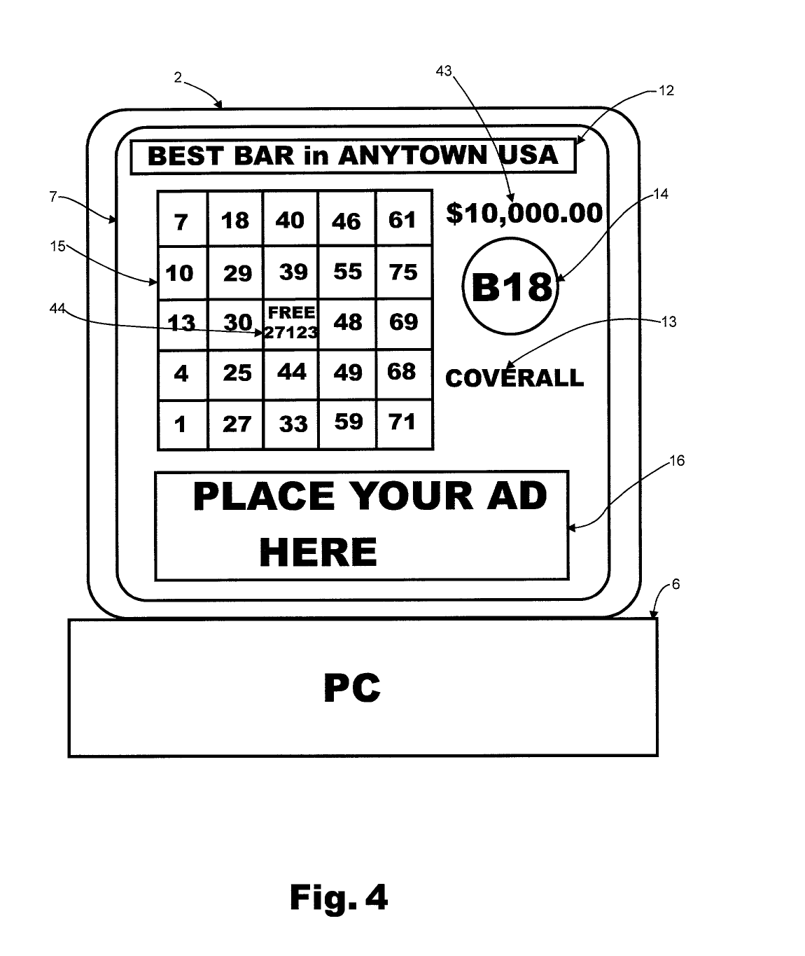

FIG. 1 illustrates a preferred embodiment of the invented linked promotional bingo game and its operation. In FIG. 1, numeral 1 denotes a central file server or central bingo game controller and numeral 2 denotes ticket dispensing kiosks (or point-of-sale terminal) installed in a plurality of bars and similar establishments. Although only two participating bars are illustrated in FIG. 1, a large number of establishments is generally envisioned to participate in a linked promotional bingo game. Note that some larger establishments, including casinos may have several kiosks 2 installed on their premises. Central file server 1 is interconnected with vending kiosks 2 over Internet 3. The central file server 1 includes a PC-compatible computer 4 and a video touchscreen monitor 5. Similarly, ticket dispensing kiosk 2 includes a PC-compatible computer 6 and a video touchscreen monitor 7. In addition, kiosk 2 includes a receipt printer 8 and a magnetic card reader 9. Receipt printer 8 is adapted to print a receipt 10 (e.g. free game ticket) as illustrated in FIG. 2 under the control of PC 6 and magnetic card reader 9 is adapted to read a magnetic strip implemented on a player-tracking card 11 illustrated in FIG. 3 under the control of PC 6. The kiosk 2 is adapted to display the participating establishment's name 12, the bingo pattern being played 13, the last called bingo number 14, the winning bingo card 15 and the commercial 16 on its touchscreen 7 as illustrated in FIG. 4.

The system of FIG. 1 is designed to create an appearance of a live linked bingo game being conducted simultaneously throughout a number of commercial establishments. In each of the participating establishments, kiosk 2 issues free game tickets 10 imprinted with bingo cards 17 to patrons who pass the magnetic strips of their player-tracking cards 11 through the magnetic card reader 9 in order to obtain free tickets 10. Preferably, only one ticket 10 per patron per game is issued. It is noted that bingo card 17 imprinted on ticket 10 is shown in FIG. 2 to be identical to the winning bingo card 15 shown in FIG. 4. However generally, it is not the case, and in fact, only one of all imprinted bingo cards 17 becomes the winning bingo card 15 in any given simulated bingo game. The kiosk 2 also displays simulated called bingo numbers 14 and the winning bingo card 15 on the touchscreen 7. However, the winning bingo card 15 is not truly a bingo card having bingo numbers 18 matching called bingo numbers 14 within a bingo pattern 13 being played. On the contrary, it is rather called bingo numbers 14 that are artificially generated to match a specific bingo card 17 imprinted on a specific free sweepstakes ticket 10 randomly selected by server 1 from a plurality of tickets 10 distributed to patrons of the establishments before the simulated bingo game even begins.

In order to simplify a description of operation of the system of FIG. 1, it is initially assumed that the simulated bingo game is a so-called “coverall” game 13 wherein to win bingo all bingo numbers on the card 17 must be covered. However, a plethora of bingo patterns, other than “coverall”, can be implemented in a similar manner. Nevertheless, the “coverall” pattern 13 may be a preferred pattern since it prolongs the bingo game tending to extend a patron's visit to the establishment. In addition, the “coverall” pattern 13 is one of the most readily familiar bingo patterns to the general public.

Generally, both the server 1 and kiosk 2 are advanced multimedia computers executing specific application in a multitasking environment, such as Linux. For the purposes of brevity, the following description omits details of conventional hardware and software design techniques. Instead, the flow charts of FIG. 1 illustrate application-specific aspects of the operation of the linked system. Specifically, the flow chart delineated by the dash-lined rectangle labeled S (underneath server 1) illustrates operation of server 1, and the flow chart delineated by the dash-lined rectangular labeled K (underneath kiosk 2) illustrates operation of kiosk 2. The flowcharts S and K are time-synchronized to illustrate the concurrent operations of server 1 and kiosk 2. The flowcharts S and K start from respective entry points 19 and 20. Both server 1 and kiosk 2 initially perform their respective initialization routines “INITIALIZE” 21 and 22 and subsequently, both wait for an appointed synchronized game-start time by looping around respective wait tests “TIME TO START?” 23 and 24. Once the game start time arrives, server 1 broadcasts commercials 16 to kiosks 2 over Internet 3 by performing output step “BROADCAST COMMERCIALS” 25. Kiosk 2 receives the commercials 16 over Internet 3 and by executing step “DISPLAY COMMERCIALS” 26 displays them on monitor 7 as illustrated in FIG. 4. Subsequent to broadcasting commercials 16 in step 25, server 1 broadcasts a command to open registration of players for the upcoming game at each participating location wherein kiosks 2 are installed. Specifically, server 1 executes output step “BROADCAST: REGISTRATION OPEN” 27. Having received the broadcast, kiosk 2 stops displaying commercials 16 and begins displaying on its screen 7 a message “REGISTRATION OPEN” as a result of execution of step “DISPLAY: REGISTRATION OPEN” 28. Thereafter, kiosk 2 starts monitoring magnetic card reader 9. Once a player swipes the magnetic strip of his or her player-tracking card 11 through card reader 9, kiosk 2 checks validity of the card 11 by executing test step “VALID PLAYER CARD?” 29. Assuming card 11 is valid (e.g., its magnetic strip 30 carries a properly formatted record of a correct length and of reasonable value and includes a matching checksum), kiosk 2 prints a free ticket 10 on printer 8 for the holder of player-tracking card 11 who's name 31 is embossed above strip 30. The printing of ticket 10 is performed at step 32. Following printing of ticket 10, kiosk 2 reports the transaction data, including all information imprinted on ticket 2 to server 1 via Internet 3 by executing step “REPORT TRANSACTION DATA TO FILE SERVER” 34.

Upon receiving the transaction data, server 1 records the transaction in its internal database specifically including player identification 33 and also charges a transaction fee to an account of the establishment wherein kiosk 2 is installed, as specified in step “STORE TRANSACTION DATA INCLUDING PLAYER ID and CHARGE SITE'S ACCOUNT” 35. For each recorded transaction, server 1 also increments an index pointing to the transaction in its database. The index starts at one corresponding to the first recorded transaction and eventually reaches a value equal to the total number of free game tickets 10 issued at all participating locations. Once processing of the received transaction is complete, server 1 checks whether it is time to end issuing free game tickets 10 at participating sites equipped with kiosks 2. Specifically, server 1 performs test step “TIME TO END?” 36. An identical test “TIME TO END?” 37 is also performed by kiosk 2. If a predetermined time to close distribution of free game tickets 10 is not yet reached, kiosk 2 returns to step 29 and continues to monitor card reader 9 for additional valid player-tracking cards 11. Similarly, server 1 returns to step 35 if the predetermined time to stop printing new tickets 10 is not yet reached and continues to accept and register new transactions at step 35. However, if the predetermined time to end issuing new tickets 10 is achieved, then kiosk 2 resumes the displaying of commercials 16 by performing step “DISPLAY COMMERCIALS” 38.

Meanwhile, server 1 having successfully exited test step 36, executes step “RANDOMLY SELECT WINNING TICKET” 39. At step 39, server 1 generates a random number in a range of one to the total number of all tickets 10 issued by all participating kiosks 2 using a conventional random number generating routine. More precisely, server 1 generates a pseudo-random number using a pseudo-random number generating routine. However, for purposes of brevity, the term “pseudo” is omitted hereinafter in all references to random number generation and utilization. The generated random number is utilized as an index to a transaction recorded in the database. In other words, the generated random number determines which specific ticket 10 is the declared winning ticket. Note than no bingo numbers have yet been called, but a winner of the current bingo game has already been determined, as is only proper for a free sweepstakes drawing.

At this point, server 1 retrieves the winning ticket 10 from the database and reads in bingo numbers 18 from the winning ticket 10. Server 1 then shuffles bingo numbers 18 using a conventional random number generation routine so that bingo numbers 18 are rearranged in a quasi-random order and declares this rearranged sequence to be the sequence of called bingo numbers 14 for the current bingo game. The aforementioned operations are performed by PC 4 of server 1 at step “GENERATE CALLED BINGO NUMBERS MATCHING THE WINNING TICKET” 40. Subsequently at step “BROADCAST BINGO NUMBERS, WINNING CARD AND PRIZE” 41, server 1 broadcasts the generated sequence of called bingo numbers 14, along with the winning card and the prize to be paid to the person holding the winning ticket 10, over Internet 3 to all participating kiosks 2.

Upon receiving the outcome of the game broadcast by server 1 at step 41, each participating kiosk 2 starts to play back the sequence of called bingo numbers 14 on its screen 7 by executing step “DISPLAY BINGO NUMBERS ONE AT A TIME” 42. Specifically, kiosk 2 displays one called bingo number 14 at a time and pauses for a predetermined time (e.g., thirty seconds) before displaying the next called bingo number 14 to create an appearance of a live bingo game. Once the entire sequence of called bingo numbers 14 is played back on screen 7, kiosk 2 displays the winning card 15, including the winning card's “face” number 44, along with the winning prize 43 on its screen 7 by executing step “DISPLAY WINNING BINGO CARD AND PRIZE” 43. At this point, the current round of the game is complete and both server 1 and kiosk 2 return to their respective beginning steps 23 and 24 in preparation for the next game.

The above description of the main principles of operation of the invention considers a simplified case of the simulated game ending in exactly twenty-four called bingo numbers 14. Since it is desirable to extend the duration of the simulated bingo game, it is beneficial to call more than twenty-four bingo “balls” 14 before the simulated game ends. However, with more than twenty four numbers being called, there is a likelihood that another bingo card 17 issued for the current game 13 may also get a bingo. The likelihood increases with the number of bingo cards 17 distributed to players and the number of called bingo “balls”. Therefore, for each simulated “extra bingo ball”, a check must be performed to ascertain that no additional winners result from calling additional bingo numbers.

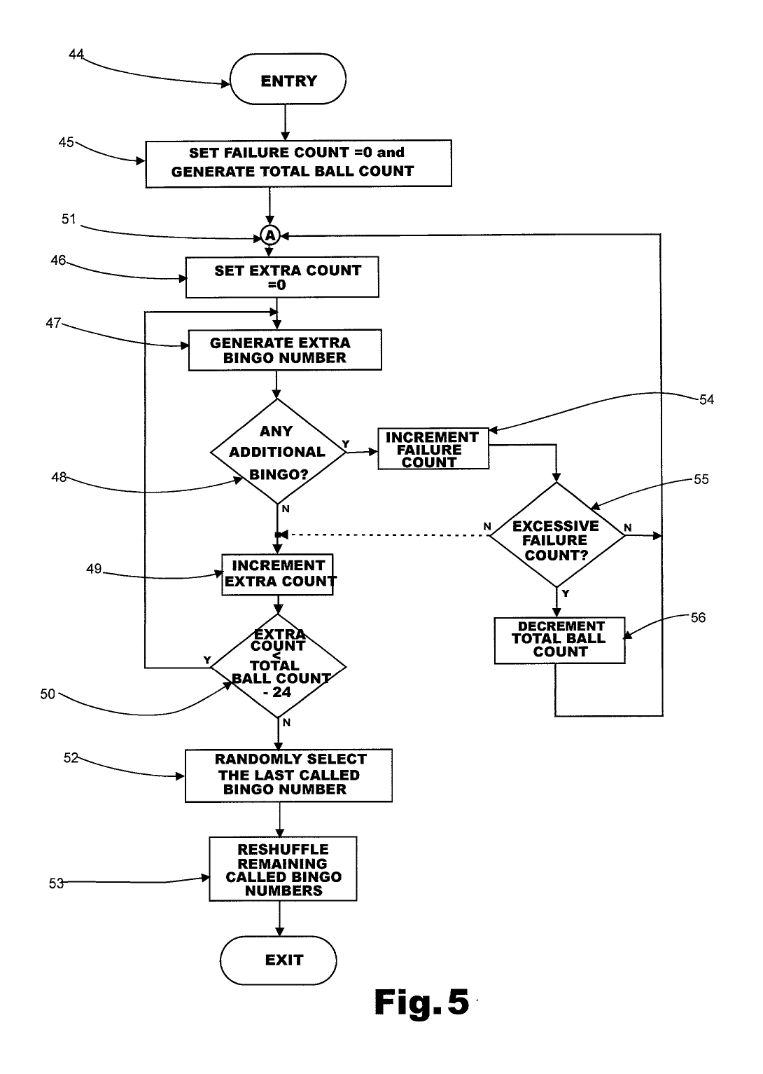

A procedure assuring the existence of a sole winner in the simulated bingo game is illustrated in the flowchart of FIG. 5. Starting from entry point 44, server 1 initializes a failure count to zero and generates a random total ball count (i.e., the total number of bingo numbers to be called in a simulated bingo game) by executing step “SET FAILURE COUNT=0 and GENERATE TOTAL BALL COUNT” 45. Note that for each type of bingo pattern, the total number of called bingo numbers falls typically within a certain range. For example, the “coverall” game 13 typically ends in fifty-to-sixty called bingo numbers. Assuming the range of fifty-to-sixty is selected for the total ball count, server 1 then randomly selects a total ball count for the current game in the above range. Since twenty-four simulated called bingo numbers are known in advance, by virtue of being equal to the winning bingo numbers 18 on the pre-selected winning bingo card 15, server 1 must randomly select the amount of simulated called bingo numbers equal to the generated TOTAL BALL COUNT less twenty-four. Having selected a total ball count in step 45, server 1 initializes a counter of generated “extra” bingo numbers to zero in step “SET EXTRA COUNT=0” 46. Subsequently, server 1 generates a first random extra bingo number by performing the step “GENERATE EXTRA BINGO NUMBER” 47. Note that server 1 first generates EXTRA BINGO NUMBER in the range one to seventy-five. Subsequently, server 1 rejects the newly generated EXTRA BINGO NUMBER if it is equal to one of the “native” bingo numbers 18 of the winning BINGO card 15. In other words, if the number is one of the bingo numbers 18 that belongs to the winning bingo card 15.

At next step “ANY ADDITIONAL BINGO?” 48, each and every bingo card 17, with the exception of the pre-selected winning bingo card 15, issued at each participating location is checked or verified for bingo. Since the techniques of computer-verification for bingo related to a plurality of bingo cards are well known as disclosed in U.S. Pat. No. 4,378,940 to Gluz et al., U.S. Pat. No. 4,455,025 to Itkis, U.S. Pat. No. 4,624,462 to Itkis and 5,951,396 to Tawil, they are omitted herein. Instead, two possible outcomes of test 48 are described herein. A negative outcome of the test 48 is considered first. If no additional bingo is discovered at step 48, the process proceeds to step “INCREMENT EXTRA COUNT” 49. At step 49 the extra count is increased by one. At subsequent step “EXTRA COUNT<TOTAL BALL COUNT−24” 50, the variable denoted as EXTRA COUNT is tested against reaching the desired TOTAL BALL COUNT. Specifically, as long as the current value of the EXTRA COUNT is less than the TOTAL BALL COUNT established at step 45 and reduced by twenty-four, the process returns to entry point 51 of the main loop. In other words, the process of generating additional called bingo numbers and checking for the absence of additional winning cards continues until the total count of called bingo numbers reaches the pre-established goal. Once test 50 fails, (e.g., all desired additional called bingo numbers are successfully generated) the process continues at step “RANDOMLY SELECT THE LAST CALLED BINGO NUMBER” 52. At step 52, server 1 randomly selects one of the native bingo numbers 18 of the winning bingo card 15 to be the last bingo number called in the simulated bingo game. The process ends with step “RESHUFFLE CALLED BINGO NUMBERS” 53. At step 53 all remaining twenty-three native bingo numbers 18 of the winning bingo card 15 are reshuffled together with all extra bingo numbers generated in step 47 and are declared to be the sequence of called bingo numbers for the current game.

In case of a positive outcome of test 48, a failure count variable is increased by one at step “INCREMENT FAILURE COUNT” 54 and is subsequently tested for reaching a pre-established threshold at step “EXCESSIVE FAILURE COUNT?” 55. If test 55 is negative, (e.g., if the current attempt to generate simulated called bingo numbers yielding a sole winner is reasonably successful by virtue of very few split winners) PC 4 returns to the entry point 51 of the main loop in order to generate a new set of simulated called bingo numbers yielding a sole winner. Note that the winning of the simulated game by only one bingo card 17 can always be guaranteed by decreasing the “overly ambitious” TOTAL BALL COUNT generated at step 45. Ultimately, the TOTAL BALL COUNT can be reduced to just twenty-four such that the uniqueness of the winning card 15 assures the existence of a sole winner of the simulated game. An assured remedy to the positive outcome of test 55 is provided at step “DECREMENT TOTAL BALL COUNT” 56 that reduces the TOTAL BALL COUNT, initially selected at step 45, by one. Once remedial step 56 is performed, PC 4 returns to the beginning of the main loop 51. The specific threshold value of the excessive ball count is a design parameter depending primarily on the computational abilities of PC 4. For example, it can be a range of one-hundred to two-hundred.

However, it is not mandatory to have a sole winner in a simulated game since in a real game of bingo, it is not unusual to split prizes between several winners. Therefore, assuming prize-splitting is legal in a jurisdiction wherein the simulated game is operated, the entire procedure of FIG. 5 can be substantially simplified by eliminating steps 48, 54, 55 and 56. Even if prize-splitting is allowed, it may still be desirable to restrict the total number of splits as indicated in FIG. 5 by means of an alternative flow path (shown in dashed lines) starting from the negative outcome of test 55 end ending at the entry point of step 49. It should be further noted that in some jurisdictions (e.g., the State of Nevada) a free live linked game of bingo is legal thereby eliminating operation of a simulated bingo game as described above. In such a favorable jurisdiction, server 1 randomly generates all called bingo numbers and checks for bingo on all registered bingo cards 17 with each new called bingo ball in order to automatically detect a winner as more fully disclosed in U.S. Pat. No. 5,951,396 to Tawil and our co-pending patent Application No. 60/241,982.

However, even if a free live game of bingo is legally permissible, a simulated game of bingo may be preferable in view of the fact that a typical bingo game prize structure is skewed towards paying larger prizes for shorter games. For example, it is customary to pay a relatively large prize for achieving a “coverall” bingo in less than fifty called numbers. It is also customary to pay a relatively small consolation prize if more than fifty numbers are called. Therefore, the entity operating a live bingo game is exposed to a risk of a long run of large-prizes. Consequently, from the game operator's perspective, the simulated bingo game described above has the advantage of ending within a pre-established total number of called bingo numbers such that the prize is known in advance. The game operator can then control the total number of called bingo numbers and by so doing can control its prize exposure. In order to make such a defacto prize control less obvious, a game operator can randomize the overall range of the total number of called bingo numbers generated at step 45. Moreover, both the total number of large prizes and the total number of small prizes may be predetermined for a series of simulated bingo games and/or a series of free game tickets. For example, it may be decided to have exactly ten large prizes and exactly ninety small prizes in a series of hundred consecutive simulated bingo games. As to the specific games in which large prizes are won, they can be determined using a random number generating utility. Similarly, it can be decided that for each one hundred thousand free tickets 10 issued, there will be exactly ten randomly selected large prize winners, with only one large prize winner per game, while the remaining winners for which the current one hundred thousand free game tickets 10 are distributed will be eligible for winning only small prizes. Such a technique is analogous to the conventional practice of randomly “inserting” high-prize winning tickets into a large “deal” of “blank” sweepstakes tickets.

Regardless of whether a free linked bingo game may be permissible in a simulated format or in a format of a true live game, there still remains the issue of funding the prizes 43 and other costs of operating the game without charging players for the game. The flowchart of FIG. 1 indicates three such potential sources of funding. First, step 35 involves charging participating establishments a fee for issuing free sweepstakes tickets 10 to patrons of the establishment. For example, each participating establishment may be charged a certain fixed fee for each ticket 10 printed at the establishment. Even though such a transaction fee may be very small (e.g., ten cents per ticket) the total amount raised from the transaction fees may be sufficient given a large number of issued tickets. Therefore, an establishment may offer an attractive prize for players while retaining a considerable amount to cover equipment and labor costs and possibly even generate a reasonable profit. In addition to directly charging the establishment various transaction fees, there exists a broad variety of other options for indirectly charging the establishment for the privilege of participation in the linked bingo game. Examples of such charges include a lease and/or rental fee for kiosk 2, a kiosk maintenance fee, training fee, software royalties, etc.

Other sources of revenue indicated in FIG. 1 include advertisements 57 printed on tickets 10 and commercials 16 displayed on screens 7 at steps 26 and 38. It is reasonable for advertisers of the commercials to pay for the privilege of exposing their products and/or services to the highly sought audience of bar, club, restaurant, casino, shopping mall and bingo hall patrons. An additional source of revenue is indicated at step 35 wherein player-tracking information is stored in the internal database of server 1. Since player tracking data, such as mailing lists of frequent players, obtained by processing the player identification numbers 33 accumulated in the database of server 1, may also be very attractive for advertisers of commercial products and services, the player-tracking data may also be commercially exploited.

It should be understood by practitioners of the art, that the present invention may be implemented otherwise than specifically described above without departing from the main principles of the invention. For example, although the above description focuses on a self-service kiosk 2, the kiosk may also be operated by an employee of the establishment (e.g., a bartender) rather than patrons. In such a situation, player-tracking card 11 may be eliminated, and instead, an employee may press a button or other input device on the kiosk's touchscreen 7 to authorize printing of a free sweepstakes ticket 10 to a patron. Also, a free ticket 10 can be automatically appended to a regular cashier receipt for food, drinks, etc. In such a case kiosk 2 serves not only as dispenser of free tickets 10, but also as a regular cash register.

We claim:

1. A method of conducting free sweepstakes based on a game of chance, said method including steps of:
(a) forming and distributing a plurality of free sweepstakes tickets bearing information related to said game of chance;
(b) designating at least one of said sweepstakes tickets as a winning ticket of said game of chance;
(c) determining a sequence of events assuring a winning of said game of chance by said designated winning ticket in accordance with rules of said game of chance; and
(d) revealing said sequence of events.

2. The method according to claim 1 wherein said game of chance is one of a series of games of chance.

3. The method according to claim 1 wherein said game of chance is bingo, said sequence of events is a sequence of called bingo numbers, said sweepstakes tickets include a depicted bingo card and said winning ticket includes a winning bingo card of said bingo game.

4. The method according to claim 1 further including a step of revealing said winning ticket.

5. The method according to claim 1 wherein said free sweepstakes tickets are printed and distributed on-demand and in real-time.

6. The method according to claim 5 wherein said free sweepstakes tickets are printed and issued at a plurality of point-of-sale terminals.

7. The method according to claim 1 wherein said designation of at least one of said free sweepstakes tickets as said winning ticket includes utilization of a pseudo-random number generator.

8. The method according to claim 1 wherein events forming said sequence of events are revealed one after another with a pause between each revealed event.

9. The method according to claim 1 wherein said free sweepstakes tickets are distributed to a plurality of participating establishments.

10. The method according to claim 9 wherein a holder of said winning ticket is awarded a prize.

11. The method according to claim 10 wherein said prize is randomly selected from a predetermined pool of prizes.

12. The method according to claim 10 wherein said winning prize is at least partially funded from proceeds generated by one or more activities included in a group consisting of:
(a) charging said participating establishments a fee for participating in said free sweepstakes;
(b) advertising at said participating establishments; and
(c) commercially exploiting player-tracking information accumulated in the process of conducting said free sweepstakes.

13. The method according to claim 12 wherein said player-tracking information includes identification of patrons of said establishments.

14. The method according to claim 12 wherein said advertising includes means for displaying one or more commercials to patrons of said establishments.

15. The method according to claim 12 wherein said advertising includes printing an advertisement on one or more of said free sweepstakes tickets.

16. The method according to claim 12 wherein said free sweepstakes tickets include identification information of patrons of said establishments.

17. The method according to claim 9 wherein said free sweepstakes tickets distributed at said participating establishments are registered on a central file server.

18. The method according to claim 17 wherein said central file server communicates with a plurality of point-of-sale terminals located at said participating establishments.

19. The method according to claim 3 further including a step of assuring said sequence of called bingo numbers results in only one winning bingo card.

20. A method of managing a free linked-game conducted simultaneously in a plurality of participating establishments including the following steps:
(a) issuing and distributing a plurality of free game tickets at said plurality of participating establishments;
(b) awarding a winning prize to a holder of at least one winning free game ticket;
(c) at least partially funding said winning prize from proceeds derived from one or more activities of the group consisting of:
(i) charging said participating establishments a fee for participating in said free sweepstakes;
(ii) advertising at said participating establishments; and
(iii) commercially exploiting player-tracking information accumulated in the process of conducting said free sweepstakes.

21. The method according to claim 20 wherein said linked-game is a game of bingo.

22. The method according to claim 20 further including means for limiting the issuance of said free tickets to one per patron of said establishments.

23. The method according to claim 20 wherein said advertising includes means for displaying one or more commercials to patrons of said establishments.

24. The method according to claim 20 wherein said advertising includes printing an advertisement on one or more of said free sweepstakes tickets.

25. The method according to claim 20 wherein said free sweepstakes tickets include identification information of patrons of said establishments.

26. The method according to claim 20 wherein said designation of at least one of said free sweepstakes tickets as said winning ticket includes utilization of a pseudo-random number generator.

27. The method according to claim 20 wherein said free game ticket winning said winning prize is determined in advance of determining a sequence of events resulting in said winning of said prize in accordance with rules of said linked-game.

28. The method according to claim 20 further including means for displaying a status of said linked-game.

29. The method according to claim 20 wherein said free sweepstakes tickets are issued and distributed at a plurality of point-of-sale terminals.
